(19) United States
(12) Patent Application Publication
(10) Pub. No.: US 2026/0018810 A1
(43) Pub. Date: Jan. 15, 2026

(54) TERMINAL BLOCK AND BUSBAR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasuhiro KUDO, Mie (JP); Daisuke HASHIMOTO, Mie (JP); Kentaro TACHI, Mie (JP); Tomoki ABE, Mie (JP); Atsuya SAIJO, Mie (JP); Yoshitomo TSUJII, Mie (JP)

(21) Appl. No.: 18/994,604

(22) PCT Filed: Jun. 28, 2023
(86) PCT No.: PCT/JP2023/023914

§ 371 Date: Jan. 15, 2025

(30) Foreign Application Priority Data
Jul. 19, 2022 (JP) 2022-114718
Nov. 15, 2022 (JP) 2022-182458

(51) Int. Cl. H01R 9/24; H02K 5/22

(52) U.S. Cl. CPC H01R 9/24; H02K 5/225

(57) ABSTRACT

It is aimed to further enhance position shift absorbing performance of a busbar itself while maintaining sealability. A terminal block to be fixed to a device includes a busbar formed into an elongated shape and a block body to be fixed to the device while holding the busbar. A part in an extension direction of the busbar is a laminated busbar portion formed by laminating a plurality of plate members, and at least a part of a remainder is a single-layer busbar portion.

### TECHNICAL FIELD

The present disclosure relates to a terminal block and a busbar.

### BACKGROUND

Patent Document 1 discloses a terminal block to be mounted on a hollow cylindrical motor case. The terminal block is used as a block for electrically connecting three busbars provided in a three-phase alternating current motor and three busbars provided in an inverter.

### PRIOR ART DOCUMENT

### Patent Document

Patent Document 1: JP 2012-186882 A

### SUMMARY OF THE INVENTION

### Problems to be Solved

In the case of integrating the inverter and the motor, the motor-side busbars and the inverter-side busbars are possibly shifted in position due to assembly tolerances, thermal expansion/contraction and the like. It is required to further enhance position shift absorbing performance of the busbars themselves while maintaining sealability.

Accordingly, the present disclosure aims to further enhance position shift absorbing performance of a busbar itself while maintaining sealability.

### Means to Solve the Problem

A terminal block of the present disclosure is to be fixed to a device and provided with a busbar formed into an elongated shape and a block body to be fixed to the device while holding the busbar, a part in an extension direction of the busbar being a laminated busbar portion formed by laminating a plurality of plate members, and at least a part of a remainder being a single-layer busbar portion.

Further, a busbar of the present disclosure is formed into an elongated shape and provided with a laminated busbar portion formed by laminating a plurality of plate members and a single-layer busbar portion joined to the laminated busbar portion.

### Effect of the Invention

According to the present disclosure, it is possible to further enhance position shift absorbing performance of a busbar itself while maintaining sealability.

### BRIEF DESCRIPTION OF THE DRAWINGS

FIG. 1 is a schematic diagram showing a mechanically/electrically integrated unit according to an embodiment.

FIG. 2 is a perspective view showing a terminal block.

FIG. 3 is a section along III-III of FIG. 2.

FIG. 4 is an enlarged view of a circled part of FIG. 3.

FIG. 5 is a perspective view showing a busbar.

FIG. 6 is a perspective view partly in section of a terminal block according to a first modification.

FIG. 7 is a perspective view partly in section of a terminal block according to a second modification.

FIG. 8 is a perspective view partly in section of a terminal block according to a third modification.

FIG. 9 is a diagram showing a skiving example.

### DETAILED DESCRIPTION TO EXECUTE THE INVENTION

### Description of Embodiments of Present Disclosure

First, embodiments of the present disclosure are listed and described.

The terminal block of the present disclosure is as follows.
(1) The terminal block is to be fixed to a device and provided with a busbar formed into an elongated shape and a block body to be fixed to the device while holding the busbar, a part in an extension direction of the busbar being a laminated busbar portion formed by laminating a plurality of plate members, and at least a part of a remainder being a single-layer busbar portion.

According to the present disclosure, the laminated busbar portion can be easily bent in a lamination direction. Thus, this busbar is better in position shift absorbing performance than a busbar formed by one metal plate. Further, even if a liquid intrudes between the plate members, this liquid is blocked by the single-layer busbar portion, which is at least a part of the remainder in the extension direction of the busbar. Thus, sealability similar to that of the busbar formed by one metal plate can be maintained.
(2) In the terminal block of (1), at least a part in the extension direction of the single-layer busbar portion may be covered by the block body.

In this case, since at least the part in the extension direction of the single-layer busbar portion is covered by the block body, the intrusion of the liquid along the outer surface of the single-layer busbar portion is also suppressed and sealability is further enhanced.
(3) In the terminal block of (2), a sealant for filling a gap between the single-layer busbar portion and the block body may be interposed between the single-layer busbar portion and the block body.

In this way, sealability between the single-layer busbar portion and the block body can be further improved by the sealant.
(4) In the terminal block of (3), a sealing groove may be formed in a direction intersecting the extension direction of the busbar in an outer peripheral surface of the single-layer busbar portion, and the sealant may be interposed between the sealing groove and the block body.

In this case, the sealant is hardly shifted in position in the extension direction of the busbar and sealability by the sealant is easily maintained.
(5) In the terminal block of any one of (1) to (4), the laminated busbar portion may include a joining portion joined to the single-layer busbar portion and an extending portion extending from the joining portion, and a tip of the extending portion may be a connection end and at least the connection end may project from the block body.

In this way, the extending portion can be easily deformed in a thickness direction when the connection end of the extending portion is connected to another electrical component. Thus, the position shift absorbing performance is excellent.
(6) In the terminal block of (5), the extending portion may include a bent portion bent to change a position of the connection end with respect to the joining portion in a thickness direction of the laminated busbar portion between the joining portion and the connection end.

The position of the connection end can be adjusted to the position of another electrical component as a connection destination by this bent portion.
(7) In the terminal block of (5) or (6), the connection end may include a screw insertion hole. In this way, the connection end can be easily connected to the other electrical component by a screw.
(8) In the terminal block of any one of (5) to (7), the single-layer busbar portion may include a single-layer joining portion joined to the joining portion and a single-layer extending portion extending from the single-layer joining portion, and a tip of the single-layer extending portion may be a single-layer connection end and at least the single-layer connection end may project from the block body.

In this case, the single-layer connection end of the single-layer busbar portion can be connected to the other electrical component. In this way, a configuration can be simplified, for example, on a connection structure side not requiring the position shift absorbing performance very much.
(9) In the terminal block of any one of (5) to (7), the laminated busbar portion may include a first laminated busbar portion and a second laminated busbar portion, each of the first and second laminated busbar portions may include the joining portion and the extending portion, and the joining portion of the first laminated busbar portion and the joining portion of the second laminated busbar portion may be joined to the single-layer busbar portion at mutually different positions.

In this way, a position shift can be absorbed at each of the connection end of the first laminated busbar portion and the connection end of the second laminated busbar portion.
(10) In the terminal block of any one of (5) to (9), a joining part of the joining portion and the single-layer busbar portion may be covered by the block body.

In this way, a joined state of the single-layer busbar portion and the laminated busbar portion is easily maintained.
(11) In the terminal block of any one of (1) to (10), a single metal member may be integrally continuous in a thickness direction in the single-layer busbar portion and divided into pieces in the thickness direction while being integrally connected to the single-layer busbar portion in the laminated busbar portion.

In this way, a gap is suppressed in the single-layer busbar portion and sealability is improved.
(12) In the terminal block of (11), the laminated busbar portion may be a part with skived plate-like parts.

In this way, the laminated busbar portion connected to the single-layer busbar portion can be easily formed.

Further, the busbar of the present disclosure is as follows.
(13) The busbar is formed into an elongated shape, and provided with a laminated busbar portion formed by laminating a plurality of plate members and a single-layer busbar portion joined to the laminated busbar portion.

According to the present disclosure, the laminated busbar portion can be easily bent in a lamination direction. This busbar is better in position shift absorbing performance than a busbar formed by one metal plate. Further, even if a liquid intrudes between the plate members, this liquid is blocked by the single-layer busbar portion, which is at least a part of a remainder in an extension direction of the busbar. Thus, sealability similar to that of the busbar formed by one metal plate can be maintained.
(14) In the busbar of (13), a single metal member may be integrally continuous in a thickness direction in the single-layer busbar portion and divided into pieces in the thickness direction while being integrally connected to the single-layer busbar portion in the laminated busbar portion.

In this way, a gap is suppressed in the single-layer busbar portion and sealability is improved.
(15) In the busbar of (14), the laminated busbar portion may be a part with skived plate-like parts.

In this way, the laminated busbar portion connected to the single-layer busbar portion can be easily formed.

### Details of Embodiment of Present Disclosure

Specific examples of a terminal block and a busbar according to the present disclosure are described below with reference to the drawings. Note that the present disclosure is not limited to these illustrations, but is represented by claims and intended to include all changes in the scope of claims and in the meaning and scope of equivalents.

### EMBODIMENT

Hereinafter, a terminal block and a busbar according to an embodiment are described. The terminal block is a component to be fixed to a device and configured to electrically connect this device to another electrical device. The busbar is one type of a wiring component for electrical connection. In this embodiment, the device is a rotating electric machine and the other electrical device is an inverter for driving and controlling the rotating electric machine. It is not essential that the device and the other electrical device are the rotating electric machine or the inverter and may be other devices such as a battery, a DC-DC converter and a junction box.

<Concerning Overall Configuration of Mechanically/Electrically Integrated Unit Incorporated with Terminal Block>

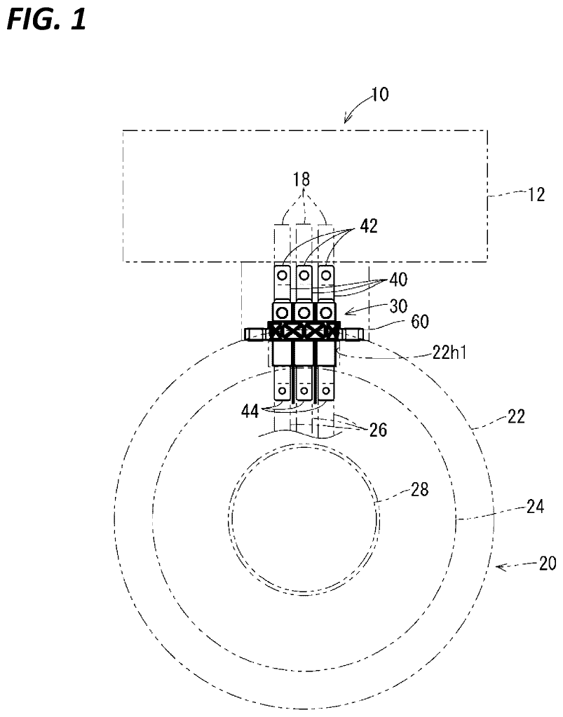

For the convenience of description, the overall configuration of a mechanically/electrically integrated unit incorporated with a terminal block including laminated busbars is described. FIG. 1 is a schematic diagram showing the mechanically/electrically integrated unit 10.

The mechanically/electrically integrated unit 10 is provided with a rotating electric machine 20 and an inverter 12.

The rotating electric machine 20 includes a case 22, an armature 24 and a field magnetic 28. An example in which the armature 24 serving as a stator is fixed in the tubular case 22 is shown in FIG. 1. The field magnet 28 is arranged as a rotor in the armature 24. The field magnet 28 is rotated by a magnetic field generated by the armature 24 or the armature 24 generates an electromotive force by the rotation of the field magnet 28. In this embodiment, the rotating electric machine 20 is assumed as a rotating electric machine usable as a three-phase alternating current motor. The rotating electric machine may be operable as a generator in addition to or instead of being operable as the motor.

The armature 24 is provided with a stator core and a plurality of coil wires. The stator core includes a plurality of teeth, which are provided to surround a rotary shaft. Each coil wire is wound on one or more teeth. Out of a plurality of end parts of the plurality of coil wires, at least some are pulled out to one end side in an axial direction of the armature from between a plurality of the teeth.

The armature 24 is provided with coil connection ends 26. The coil connection end 26 is, for example, an elongated electrically conductive plate-like part. The coil connection end 26 is arranged on the one end side in the axial direction of the armature 24. The coil connection end 26 is formed with a screw insertion hole 26h. The coil connection end 26 may be an end part of the coil wire itself or may be a metal plate connected to the coil wire by welding, screwing or the like. In this embodiment, three coil connection ends 26 corresponding to three phases are arranged in parallel at intervals on the one end side of the armature 24. The coil connection end 26 is an example of an electrical component as a connection destination of a busbar 40.

Further, the inverter 12 is a device including an inverter circuit. The inverter 12 is assumed to be integrated with the rotating electric machine 20. For example, the inverter 12 is integrated with the case 22 of the rotating electric machine 20 by bolting or the like.

The inverter 12 is provided with inverter-side busbars 18 connected to an output end of the inverter circuit. The inverter-side busbar 18 is an elongated plate-like member formed by a metal plate member of copper, copper alloy or the like. The inverter-side busbar 18 is formed with a screw insertion hole 18h for screwing. In this embodiment, three inverter-side busbars 18 corresponding to the three phases extend in parallel at intervals from the inverter 12 toward the rotating electric machine 20. The inverter-side busbar 18 is an example of an electrical component as a connection destination of the busbar 40.

The terminal block 30 is a component to be fixed to the case 22 of the rotating electric machine 20 and configured to connect the rotating electric machine 20 and the inverter 12. The terminal block 30 is provided with the busbars 40. The busbar 40 includes a first connection end 42 and a second connection end 44.

The first connection end 42 is an end part of the busbar 44 facing outward of the case 22. The first connection end 42 is supported at a position facing outward of the case 22 and connectable to an end part of the busbar 18 of the inverter 12. The first connection end 42 is arranged at a position to overlap the busbar 18 with the inverter 12 integrated with the rotating electric machine 20.

The second connection end 44 is an end part of the busbar 44 facing inward of the case 22. The second connection end 44 is facing inward of the case 22 and connected to an end part of the coil connection end 26. With the terminal block 30 fixed to the case 22, the second connection end 44 is arranged at a position to overlap the coil connection end 26.

In this embodiment, three busbars 40 corresponding to the three phases are arranged in parallel at intervals. The number of the busbars 40 is arbitrary.

In integrating the inverter 12 with the rotating electric machine 20, the end parts of the busbars 18 and the first connection ends 42 of the busbars 40 may be shifted in position within an assembly tolerance range. Further, with the inverter 12 integrated with the rotating electric machine 20, the end parts of the busbars 18 and the first connection ends 42 of the busbars 40 may be shifted in position due to thermal expansion/contraction.

This terminal block 30 can function to absorb position shifts between the end parts of the busbars 18 and the first connection ends 42 of the busbars 40.

Further, sealability may be required inside and outside the case 22. For example, sealability for preventing oil in the case 22 from leaking to outside along the busbars 40 may be desired. Further, sealability for preventing water outside the case 22 from intruding into the case 22 along the busbars 40 may be desired. This terminal block 30 can function to suppress the leakage or intrusion of a liquid along the busbars 40.

Further, the coil connection end 26 may be deviated from a predetermined position within the assembly tolerance range. Further, the coil connection end 26 may be deviated from the predetermined position due to thermal expansion/contraction. Thus, the coil connection end 26 and the second connection end 44 of the busbar 40 may be shifted in position.

This terminal block 30 may function to absorb position shifts between the coil connection ends 26 and the second connection ends 44 of the busbars 40 in addition to or instead of functioning to absorb the position shifts between the end parts of the busbars 18 and the first connection ends 42 of the busbars 40. In a second modification to be described later, the terminal block 30 functions to absorb the position shifts between the coil connection ends 26 and the second connection ends 44 of the busbars 40.

### <Concerning Terminal Block>

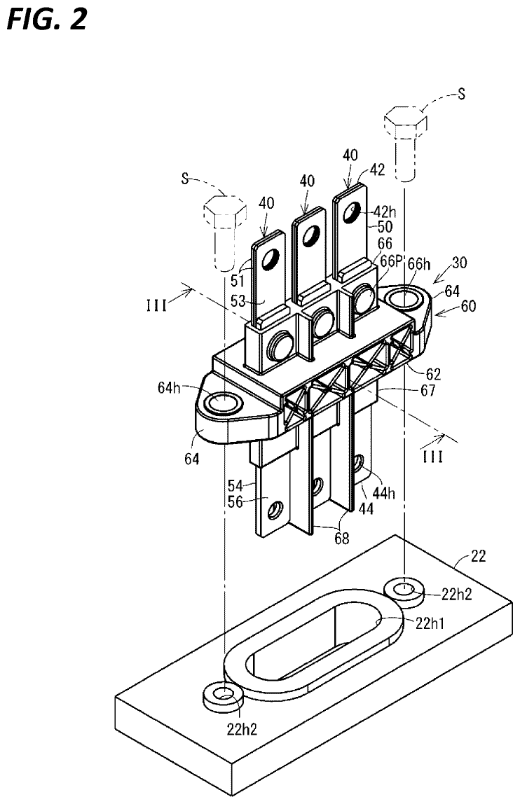

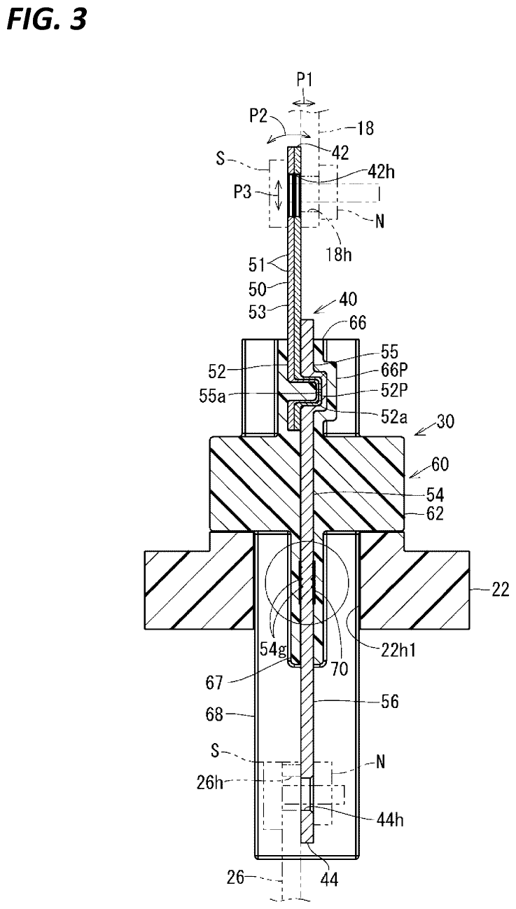

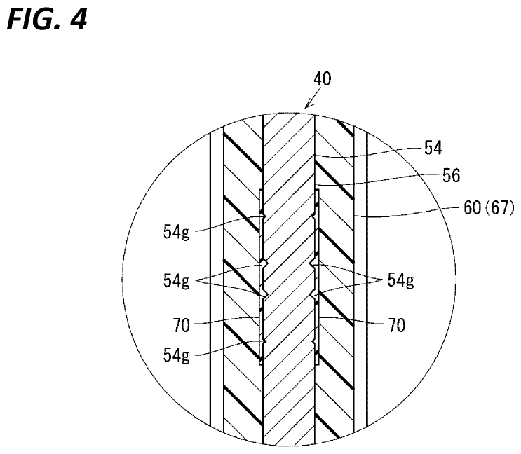

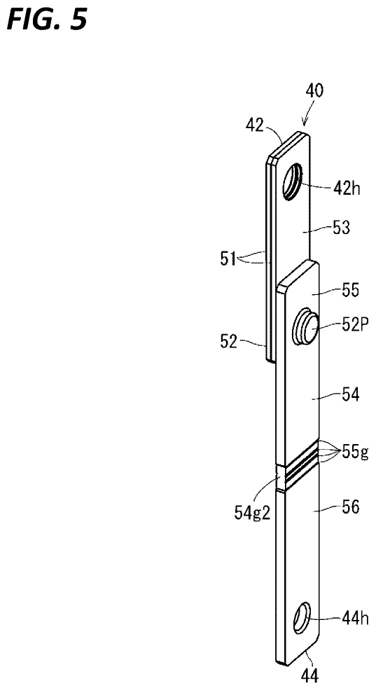

The terminal block 30 is more specifically described. FIG. 2 is a perspective view showing the terminal block 30. FIG. 3 is a section along III-III of FIG. 2. A state where the terminal block 30 is removed from the case 22 is shown in FIG. 2. A state where the terminal block 30 is fixed to the case 22 is shown in FIG. 3. In FIGS. 2 and 3, the case 22 is partially shown. FIG. 4 is an enlarged view of a circled part of FIG. 3. FIG. 5 is a perspective view showing the busbar 40.

The terminal block 30 is provided with the busbars 40 and a block body 60.

The busbar 40 is an electrically conductive component formed into an elongated shape. One end of the busbar 40 is the first connection end 42, and the other end of the busbar 40 is the second connection end 44.

The first connection end 42 is formed with a screw insertion hole 42h. With the end part of the busbar 18 overlapped on the first connection end 42, a screw S is inserted through the screw insertion holes 18h, 42h and this screw S is threadably fastened to a nut N. Then, the first connection end 42 and the end part of the busbar 18 are sandwiched between a head part of the screw S and the nut N and fixed while being electrically connected.

The screw insertion hole 42h is preferably larger than a diameter of a screw shaft part of the screw S. The screw insertion hole 42h may be set to be larger than the diameter of the screw shaft part of the screw S to be able to absorb the position shift between the first connection end 42 and the end part of the busbar 18 within the tolerance range in a direction along overlapping surfaces of the first connection end 42 and the end part of the busbar 18. The above position shift can be absorbed also by the screw insertion hole 18h larger than the diameter of the screw shaft part of the screw S. Thus, the size of the screw insertion hole 42h may be set also in consideration of the size of the screw insertion hole 18h.

The second connection end 44 is formed with a screw insertion hole 44h. With the coil connection end 26 overlapped on the second connection end 44, a screw S is inserted through the screw insertion holes 26h, 44h and this screw S is threadably fastened to a nut N. Then, the second connection end 44 and the coil connection end 26 are sandwiched between a head part of the screw S and the nut N and fixed while being electrically connected.

The screw insertion hole 44h is preferably larger than a diameter of a screw shaft part of the screw S. The screw insertion hole 44h may be set to be larger than the diameter of the screw shaft part of the screw S to be able to absorb the position shift between the second connection end 44 and the coil connection end 26 within the tolerance range in a direction along overlapping surfaces of the second connection end 44 and the coil connection end 26. The above position shift can be absorbed also by the screw insertion hole 26h larger than the diameter of the screw shaft part of the screw S. Thus, the size of the screw insertion hole 44h may be set also in consideration of the size of the screw insertion hole 26h.

In this embodiment, the terminal block 30 is provided with the three busbars 40. The terminal block 30 may be provided with at least one busbar.

A part in an extension direction of the busbar 40 is a laminated busbar portion 50, and at least a part of a remainder is a single-layer busbar portion 54. In this embodiment, a part of the busbar 40 near the first connection end 42 is the laminated busbar portion 50, and a part of the busbar 40 from a central part in the extension direction of this busbar 40 to a part near the second connection end 44 is the single-layer busbar portion 54. The laminated busbar portion 50 and the single-layer busbar portion 54 are partially overlapped and joined at a position closer to the first connection end 42 than a center in the extension direction of the busbar 40.

The laminated busbar portion 50 is a part where a plurality of plate members 51 are laminated. The plate member 51 is thinner than the entire laminated busbar portion 50 and thinner than the single-layer busbar portion 54. The plate member 51 is constituted by a metal plate of copper, copper alloy, aluminum, aluminum alloy or the like. The plate member 51 is in the form of an elongated plate. In the laminated busbar portion 50, the plurality of plate members 51 are overlapped with extension directions thereof aligned, wherefore the laminated busbar portion 50 is also in the form of an elongated plate.

More specifically, the laminated busbar portion 50 is formed into a rectangular shape long in one direction. End parts of the laminated busbar portion 50 are also assumed to be rounded. In this embodiment, two plate members 51 are overlapped. Three or more plate members may be overlapped.

The laminated busbar portion 50 includes a joining portion 52 and an extending portion 53. The joining portion 52 is a part overlapped on and joined to the single-layer busbar portion 54.

The extending portion 53 is a part extending from the joining portion 52. In this embodiment, the extending portion 53 extends in a direction opposite to an extension direction of the single-layer busbar portion 54. That is, the joining portion 52 of the laminated busbar portion 50 is joined to the single-layer busbar portion 54, and the laminated busbar portion 50 and the single-layer busbar portion 54 linearly extend.

The tip of the extending portion 53 is the first connection end 42. As described above, the first connection end 42 is formed with the screw insertion hole 42h. For example, each plate member 51 is formed with a hole for forming the screw insertion hole 42h. By overlapping the plurality of plate members 51, the holes of the plate members are overlapped to form the screw insertion hole 42h.

As described later, if the laminated busbar portion 50 is deformed in a lamination direction, the holes are assumed to be shifted in position between the laminated plate members 51. The holes are preferably larger than the diameter of the screw S so that the screw S can be inserted through the screw insertion hole 42h even if the positions of the holes are shifted.

A thickness and a width of the laminated busbar portion 50, a thickness and a width of the plate member 51 and the number of the plate members are arbitrary. These thicknesses, widths and number are set in consideration of an allowable current value, ease of deformation, processibility and the like required for the busbar 40.

It is not essential that the plurality of plate members 51 are formed into the same shape. For example, a laminated busbar portion may be configured by laminating a plurality of plate members having different thicknesses. Further, the plurality of plate members 51 may be formed with holes having different shapes, and the screw insertion hole 42h may be formed by common opening parts of the plurality of holes.

The plurality of plate members 51 are laminated in a relatively position shiftable state at least in a part of the laminated busbar portion 50. Lamination of the plurality of plate members 51 in the relatively position shiftable state means that the adjacent plate members 51 are not joined to each other and, accordingly, the respective plate members 51 can be bent in a thickness direction (lamination direction of the laminated busbar portion 50) to be rubbed against each other.

In this embodiment, the plurality of plate members 51 are laminated in the relatively position shiftable state in a region of the laminated busbar portion 50 except the joining portion 52, i.e. in the extending portion 53. Thus, the laminated busbar portion 50 can be more easily bent in the thickness direction than the single-layer busbar portion 54 in the region extending from the single-layer busbar portion 54.

The single-layer busbar portion 54 is not formed by joining a plurality of plate members, but is a part having a single layer structure, in which the same material is continuous in a thickness direction. The single-layer busbar portion 54 is, for example, constituted by one metal plate. The metal plate is, for example, made of copper, copper alloy, aluminum, aluminum alloy or the like.

The single-layer busbar portion 54 is formed into an elongated shape, more specifically a rectangular shape long in one direction. In this embodiment, the single-layer busbar portion 54 includes a single-layer joining portion 55 and a single-layer extending portion 56.

The single-layer joining portion 55 is a part overlapped on and joined to the laminated busbar portion 50.

In this embodiment, the joining portion 52 and the single-layer joining portion 55 are press-worked to keep a joined state.

In this embodiment, one of the joining portion 52 and the single-layer joining portion 55 is formed with a protrusion 52a projecting in the thickness direction, the other is formed with a recess 55a recessed in the thickness direction and the joining portion 52 and the single-layer joining portion 55 are joined by fitting the protrusion 52a into the recess 55a.

Such a joint structure is, for example, formed by press-working with the joining portion 52 and the single-layer joining portion 55 overlapped. Such a joint structure may be, for example, a structure called a crimp joint, may be a structure called a TOX (trademark) crimp, or may be a structure called a mechanical clinch.

In the joining portion 52, the plurality of plate members 51 are also press-worked to keep a joined state. Here, a protrusion formed on either one of the plate members 51 is fit into a recess formed in the adjacent plate member, whereby the plate members 51 are fixed in a laminated state.

That is, in this embodiment, the plurality of plate members 51 and the single-layer joining portion 55 are press-worked with the plurality of plate members 51 and the single-layer joining portion 55 overlapped each other, whereby the plurality of plate members 51 are joined to each other and the plurality of plate members 51 and the single-layer joining portion 55 are joined. Thus, the holding of the plate members 51 in the overlapped state and the joint of the joining portion 52 and the single-layer joining portion 55 are realized by the same process, wherefore the busbar 40 is easily manufactured.

Note that the joining portion 52 and the single-layer joining portion 55 only have to be electrically and mechanically joined, and may be joined by any configuration without limitation to the above example. For example, the joining portion and the single-layer joining portion may be joined by welding or screwing. Further, the plate members 51 also only have to be electrically and mechanically joined to each other, and may be joined by any configuration without limitation to the above example. For example, the plate members may be joined to each other by welding or screwing. Further, the joint of the joining portion and the single-layer joining portion and the joint of the plate members need not be realized by the same joint structure. For example, the plate members may be joined to each other by welding, and the joining portion and the single-layer joining portion may be joined by crimping or screwing.

In the following description, a part functioning to electrically and mechanically join the joining portion 52 and the single-layer joining portion 55 is referred to as a joining part 52P. For example, the part where the protrusion 52a is fit into the recess 55a to realize the electrical and mechanical joining part is the joining part 52P.

The single-layer extending portion 56 is a part extending from the single-layer joining portion 55. In this embodiment, the single-layer extending portion 56 extends toward a side opposite to the extending portion 53.

The tip of the single-layer extending portion 56 is the second connection end 44, and the second connection end is an example of a single-layer connection end. As described above, the second connection end 44 is formed with the screw insertion hole 44h.

Sealing grooves 54g extending in a direction intersecting the extension direction of the busbar 40 are formed in the outer peripheral surface of the single-layer busbar portion 54. A part of the single-layer busbar portion 54 where the sealing grooves 54g are formed is a part to be covered by the block body 60. In this embodiment, the sealing grooves 54g are formed in each of both surfaces of a part of the single-layer extending portion 56 between the single-layer joining portion 55 and the second connection end 44. In each surface, a plurality of (four) sealing grooves 54g are formed at intervals along the extension direction of the busbar 40. Each sealing groove 54g extends in a direction orthogonal to the extension direction of the busbar 40.

It is not essential that the sealing grooves 54g are configured as described above. At least one sealing groove may be provided. The sealing groove may extend obliquely to the extension direction of the busbar. The sealing groove may be formed in a side part of the busbar.

Note that, in this embodiment, recesses 54g2 are partially formed in regions including formation regions of the plurality of sealing grooves 54g in the both side parts of the busbar 40.

A thickness and a width of the single-layer busbar portion 54 are arbitrary. These thickness and width are set in consideration of the allowable current value and the like required for the busbar 40.

In the busbar 40, a length of the laminated busbar portion 50 and that of the single-layer busbar portion 54 are arbitrary. As the laminated busbar portion 50 becomes longer, the laminated busbar portion 50 can be more easily bent in the lamination direction. Further, as the single-layer busbar portion 54 becomes longer, a region where the leakage or intrusion of a liquid between and along the plate members 51 can be suppressed can be increased. The lengths of the laminated busbar portion 50 and the single-layer busbar portion 54 can be set according to desired position shift absorbing performance, sealability and the like.

The block body 60 is a part to be fixed to the rotating electric machine 20, which is an example of a device, while holding the busbars 40. Here, the case 22 of the rotating electric machine 20 is formed with a mounting hole 22h1. The mounting hole 22h1 is a hole penetrating between inside and outside of the case 22. In this embodiment, the mounting hole 22h1 is an elongated through hole. The case 22 is formed with a flat part, and the mounting hole 22h1 is formed in that flat part. Screw holes 22h2 are formed around the mounting hole 22h1 in this flat part. In this embodiment, the screw holes 22h2 are formed on both outer sides in a longitudinal direction of the mounting hole 22h1 in the case 22. With a part of the block body 60 inserted in the mounting hole 22h1, the block body 60 is screwed and fixed to the case 22, using the screw holes 22h2.

The block body 60 is, for example, assumed as an insulator such as a resin. The resin for forming the block body 60 is, for example, a polyamide 6T (PA6T), a polyphenylene sulfide (PPS) or a polybutylene terephthalate (PBT), and PA6T is more preferable. If the rotating electric machine 20 is of an oil-cooled type, the resin for forming the block body 60 is preferably PA6T or PPS. If the rotating electric machine 20 is of a water-cooled state, the resin for forming the block body 60 may be PBT. The plurality of busbars 40 are supported at fixed positions with respect to the rotating electric machine 20 by the block body 60.

The block body 60 is provided with a holding body 62, screwing portions 64, extended holding portions 66, 67 and partitioning portions 68.

The holding body 62 is formed into a shape to close an outer opening of the mounting hole 22h1 and cover an outer opening peripheral edge part of the mounting hole 22h1, here into a rectangular plate shape expanding to be larger than the outer opening of the mounting hole 22h1.

The screwing portion 64 is a part projecting from the outer periphery of the holding body 62. In this embodiment, the block body 60 includes two screwing portions 64. The two screwing portions 64 project outward from both longitudinal ends of the holding body 62. The screwing portion 64 is formed with a screw insertion hole 64h.

With the holding body 62 covering the outer opening of the mounting hole 22h1, the holding body 62 can be in contact with the outer surface of the case 22 around the mounting hole 22h1. In this state, the pair of screwing portions 64 are arranged on the pair of screw holes 22h2. The block body 60 is fixed to the case 22 by inserting screws S through the screw insertion holes 64h and being threadably fastened to the screw holes 22h2 of the case 22.

In this state, the holding body 62 is pressed against the outer surface of the case 22 around the mounting hole 22h1, thereby sealing between the block body 60 and the case 22. Preferably, an annular seal made of rubber or the like may be interposed between the block body 60 and the case 22. Further, the block body 60 may include an inserting portion to be inserted into the mounting hole 22h1 and the annular seal may be interposed between this inserting portion and the mounting hole 22h1. In this case, sealability between the mounting hole and the block body is further improved by the annular seal.

The busbars 40 are held by the holding body 62 to penetrate between the inside and outside of the case 22. In this embodiment, a plurality of (three) busbars 40 are held in parallel at intervals by the holding body 62. The plurality of (three) busbars 40 are kept insulated from each other by the holding body 62.

An intermediate part in the extension direction of the busbar 40 is embedded in the holding body 62. Out of the laminated busbar portion 50, a part on the side of the first connection end 42 projects outwardly of the case 22 from the holding body 62. A part of the busbar 40 on the side of the second connection end 44 projects into the inside of the case 22 from the holding body 62.

With the block body 60 fixed to the case 22 as described above, the first connection ends 42 of the busbars 40 are arranged at positions capable of overlapping the busbars 18. Further, the second connection ends 44 of the busbars 40 are arranged at positions capable of overlapping the coil connection ends 26.

The extended holding portion 66 projects outwardly of the case 22 from the block body 60 while partially covering the respective busbars 40. Therefore, parts of the busbars 40 near the first connection ends 42 and coming out from a tip side of the extended holding portion 66 are exposed from the block body 60.

The extended holding portion 67 projects into the inside of the case 22 from the block body 60 while partially covering the respective busbars 40. Therefore, parts of the busbars 40 near the second connection ends 44 and coming out from a tip side of the extended holding portion 67 are exposed from the block body 60.

The partitioning portions 68 are plate-like parts extending in a direction orthogonal to an arrangement direction of the plurality of busbars 40 more inside the case 22 than the block body 60 and between the respective busbars 40. The partitioning portions 68 extend further inwardly of the case 22 than the extended holding portion 67. Such partitioning portions 68 can partition between the parts of the respective busbars 44 near the second connection ends 44.

The extended holding portions 66, 67 may be omitted. The partitioning portions 68 may be omitted.

A relationship of the laminated busbar portion 50 and the single-layer busbar portion 54 in the busbar 40 is described.

First, at least a part in the extension direction of the single-layer busbar portion 54 is covered by the block body 60. More specifically, out of the single-layer extending portion 56 of the single-layer busbar portion 54, a part near the single-layer joining portion 55 is covered by the block body 60. Particularly, a part formed with the sealing grooves 54g, out of the single-layer extending portion 56, is covered by the block body 60.

In this embodiment, an end part of the single-layer joining portion 55 is exposed from the extended holding portion 66 of the block body 60. The end part of the single-layer joining portion 55 may be covered by the block body 60.

The first connection end 42 located on the end part of the laminated busbar portion 50 projects from the block body 60, more specifically from the extended holding portion 66. In this embodiment, out of the laminated busbar portion 50, at least a part of the joining portion 52 is covered by the extended holding portion 66 of the block body 60 and the extended holding portion 66 extends from the joining portion 52 and further projects from a tip part of the extended holding portion 66. In this way, the first connection end 42 on the tip of the extending portion 53 projects from the extended holding portion 66 of the block body 60.

Further, the joining part 52P of the joining portion 52 and the single-layer joining portion 55 is covered by the block body 60. In this embodiment, the joining part 52P is covered by the extended holding portion 66 of the block body 60. Note that since the joining part 52P partially projects further than the single-layer joining portion 55 in this embodiment, the extended holding portion 66 includes a partial protrusion 66P partially projecting in the joining part 52P. The joining part 52P is covered by the partial protrusion 66P. In this way, the partially projecting joining part 52P can be covered while the extended holding portion 66 is made as thin as possible.

The second connection end 44 located on the tip of the single-layer busbar portion 54 projects from the block body 60, more specifically from the extended holding portion 67. In this embodiment, out of the single-layer busbar portion 54, at least a part of the single-layer joining portion 55 is covered by the extended holding portion 66 of the block body 60 and the single-layer extending portion 56 extends from the single-layer joining portion 55 and projects from a tip part of the extended holding portion 67 through the insides of the holding body 62 and the extended holding portion 67. In this way, the second connection end 44 on the tip of the single-layer extending portion 56 projects from the extended holding portion 67 of the block body 60.

Further, a sealant 70 for filling a gap between the single-layer busbar portion 54 and the block body 60 is preferably interposed between the single-layer busbar portion 54 and the block body 60. The sealant 70 needs not be present entirely on a part of the single-layer busbar portion 54 to be covered by the block body 60, but may be interposed between at least a part of the part to be covered by the block body 60, out of the single-layer busbar portion 54, and the block body 60. Here, the sealant 70 is interposed between the single-layer busbar portion 54 and the extended holding portion 67.

The sealant 70 functions to close a liquid intrusion path between the single-layer busbar portion 54 and the block body 60 by being interposed between the single-layer busbar portion 54 and the block body 60. For example, an elastic adhesive can be used as the sealant 70. For example, an epichlorohydrin rubber adhesive can be used.

In this embodiment, the single-layer busbar portion 54 is formed with the sealing grooves 54g and the sealant 70 is interposed between the sealing grooves 54g and the block body 60. That is, the sealant 70 is interposed between the single-layer busbar portion 54 and the block body 60 while being filled in at least parts of the sealing grooves 54g. In this embodiment, the sealant 70 is also filled in the recesses 54g2 formed on the both sides of the single-layer busbar portion 54 and interposed between the single-layer busbar portion 54 and the block body 60. Thus, the sealant 70 is easily interposed between the single-layer busbar portion 54 and the block body 60 while surrounding the single-layer busbar portion 54 entirely.

The terminal block 30 is, for example, manufactured as follows. That is, the end parts of the plurality of plate members 51 for constituting the laminated busbar portion 50 are overlapped on the single-layer joining portion 55 of the single-layer busbar portion 54. Then, press-working or the like is applied to the single-layer joining portion 55 and the end parts of the plurality of plate members 51. In this way, the plurality of plate members 51 are joined by the joining portion 52 and held in an overlapped state. Further, the joining portion 52 of the laminated busbar portion 50 and the single-layer joining portion 55 of the single-layer busbar portion 54 are joined, and the laminated busbar portion 50 and the single-layer busbar portion 54 are linearly connected and coupled. Then, the sealant 70 is attached around the part formed with the sealing grooves 54g, out of the single-layer busbar portion 54.

The busbars 40 are set in a mold for molding the block body 60. A molten resin for forming the block body 60 is poured into the mold, and the block body 60 is molded with the busbars 40 as inserts. In this way, the terminal block 30 is manufactured in which the intermediate parts in the extension direction of the busbars 40 are embedded as insert parts in the block body 60. Collars made of metal may be embedded in the screw holes 64h.

Unlike the above manufacturing method, the terminal block 30 may be manufactured by, after the block body 60 including through holes, through which the busbars 40 are insertable, is molded, inserting the busbars 40 into these through holes. An operation example of connecting the rotating electric machine 20 and the inverter 12 by the above terminal block 30 is described.

First, it is assumed for the rotating electric machine 20 that the armature 24 and the like are incorporated into the case 22 and the coil connection ends 26 are arranged at predetermined positions in the case 22. In this state, the block body 60 is arranged at a position to cover the mounting hole 22h1 of the case 22. In this state, the second connection ends 44 are arranged at positions to overlap the coil connection ends 26. Then, the second connection ends 44 and the coil connection ends 26 are screwed and fixed in a state overlapped and held in surface contact with each other.

Before or after the second connection ends 44 and the coil connection ends 26 are screwed and fixed, the block body 60 is screwed and fixed to the case 22.

The first connection ends 42 of the laminated busbar portions 50 are projecting outside the terminal block 30 fixed to the case 22. The inverter 12 is arranged on the rotating electric machine 20, and the end parts of the busbars 18 are arranged at positions to overlap the first connection ends 42. However, the position of at least one of the first connection end 42 and the end part of the busbar 18 may be possibly deviated from a predetermined position in design in the lamination direction of the laminated busbar portion 50 (see arrows P1 of FIG. 3). In such a case, the part near the first connection end 42, out of the laminated busbar portion 50, can be easily bent in the lamination direction according to the position of the end part of the busbar 18 (see arrows P2 of FIG. 2). In this way, the first connection end 42 and the end part of the busbar 18 can be screwed and fixed in a state overlapped and held in surface contact with each other.

In this case, the position of at least one of the first connection end 42 and the end part of the busbar 18 may be possibly deviated from the predetermined position in design in a direction orthogonal to the lamination direction of the laminated busbar portion 50 (see arrows P3 of FIG. 3). In preparation for such a case, at least one of the screw insertion hole 42h and the screw insertion hole 18h may be, for example, made larger than the diameter of the screw shaft of the screw S. In this case, the first connection end 42 and the end part of the busbar 18 can be screwed and fixed in a state where the screw S is inserted through the screw insertion hole 42h or 18h at a position shifted according to a deviation amount.

Note that the first connection ends 42 and the second connection ends 44 are screwed and fixed in an arbitrary order.

Even after the inverter 12 is integrated with the rotating electric machine 20, a position shift between the first connection end 42 and the end part of the busbar 18 may occur or be increased due to thermal expansion/contraction or the like. Also in such a case, the part near the first connection end 42, out of the laminated busbar portion 50, is easily deformed in the lamination direction, whereby this position shift can be dealt with.

It may be desired to suppress the passage of a liquid between the inside and outside of the rotating electric machine 20 with the inverter 12 integrated with the rotating electric machine 20. For example, if the rotating electric machine 20 is of the oil-cooled type, oil is present in the case 22. It is required to prevent the leakage of the oil to the outside of the rotating electric machine 20 also in the terminal block 30.

Since the plate members 51 are overlapped in the laminated busbar portion 50 of the busbar 40, a tiny gap is possibly formed between the plate members 51. However, out of the busbar 40, the part to be embedded in the block body 60 includes the single-layer busbar portion 54. Thus, the passage of a liquid by way of the inside of the busbar 40 is blocked by this single-layer busbar portion 54.

Further, a tiny gap is possibly formed also between the busbar 40 and the block body 60.

Further, a tiny gap is possibly formed also between the outer surface of the busbar 40 and the block body 60. However, since the sealant 70 is interposed between the single-layer busbar portion 54 and the block body 60, the passage of a liquid through between the outer peripheral surface of the busbar 40 and the block body 60 is suppressed. Particularly, since the sealant 70 is interposed between the sealing grooves 54g and the block body 60, the sealant 70 is hardly displaced from the outer peripheral surface of the busbar 40 and a state where the sealant 70 is interposed between the outer peripheral surface of the busbar 40 and the block body 60 is more reliably maintained. Thus, sealing is more reliably provided between the outer peripheral surface of the busbar 40 and the block body 60 by the sealant 70.

Accordingly, oil leakage from the case 22 is suppressed in the terminal block 30.

Note that sealing is provided to prevent the passage of a liquid such as water through the terminal block 30 also when the rotating electric machine 20 is not of the oil-cooled type.

### <Effects, Etc.>

According to the terminal block 30 and the busbar 40 configured as described above, the laminated busbar portion 50 can be easily bent in the lamination direction. Thus, this busbar 40 is better in position shift absorbing performance than a busbar formed by one metal plate and having the same thickness. Further, even if a liquid intrudes into between the plate members 51, the liquid is blocked by the single-layer busbar portion 54, which is at least a part of a remainder in the extension direction of the busbar 40. Thus, the liquid is less likely to be transferred than a laminated busbar in which plate members are laminated entirely in an extension direction. Thus, sealability similar to that of a busbar formed by one metal plate can be maintained. Therefore, the position shift absorbing performance of the busbar 40 itself can be further enhanced while sealability is maintained.

Further, since a part coming out from the terminal block 30, out of the laminated busbar portion 50, can be entirely bent in the thickness direction to absorb a position shift, stress is hardly concentrated on the busbar 40 and the block body 60. In this way, the busbar 40 and the block body 60 are hardly broken.

Further, since the laminated busbar portion 50 is deformed as described above, the position shift hardly generates a force for displacing the terminal block 30 with respect to the case 22 or deforming the terminal block 30. In this way, sealability between the block body 60 and the case 22 is hardly reduced.

Further, since at least a part of the single-layer busbar portion 54 is covered by the block body 60, the intrusion of a liquid along the outer surface of the single-layer busbar portion 54 is also suppressed and sealability is further enhanced.

Further, sealability between the single-layer busbar portion 54 and the block body 60 can be further improved by the sealant 70 interposed between the single-layer busbar portion 54 and the block body 60.

Further, since the sealant 70 is interposed between the sealing grooves 54g and the block body 60, the sealant 70 is hardly displaced along the extension direction of the busbar 40 and the sealing grooves 54g can be interposed at a stable position between the single-layer busbar portion 54 and the block body 60. In this way, sealability by the sealant 70 is easily maintained.

Further, since the first connection end 42 located on the tip of the extending portion 53 of the laminated busbar portion 50 comes out from the block body 60, the extending portion 53 can be deformed in the thickness direction when the first connection end 42 is connected to the busbar 18. Thus, a part near the first connection end 42 can be deformed and the position shift absorbing performance is excellent.

Further, since the screw insertion hole 42h is formed in the first connection end 42, the first connection end 42 can be easily connected to the busbar 18 by the screw S.

Further, since the second connection end 44 located on the tip of the singe-layer extending portion 56 of the single-layer busbar portion 54 extends out from the block body 60, the second connection end 44 can be connected to the coil connection end 26. For example, if the coil connection end 26 is easily deformed and a position adjustment is not necessary on the side of the second connection end 44, a configuration on the side of the second connection end 44 can be simplified such as when the coil connection end 26 and the second connection end 44 can be precisely arranged.

Further, since the joining part 52P of the joining portion 52 and the single-layer joining portion 55 is covered by the block body 60, this joining part 52P is reinforced also by the block body 60. In this way, the joined state of the single-layer busbar portion 54 and the laminated busbar portion 50 is easily maintained.

### [Modifications]

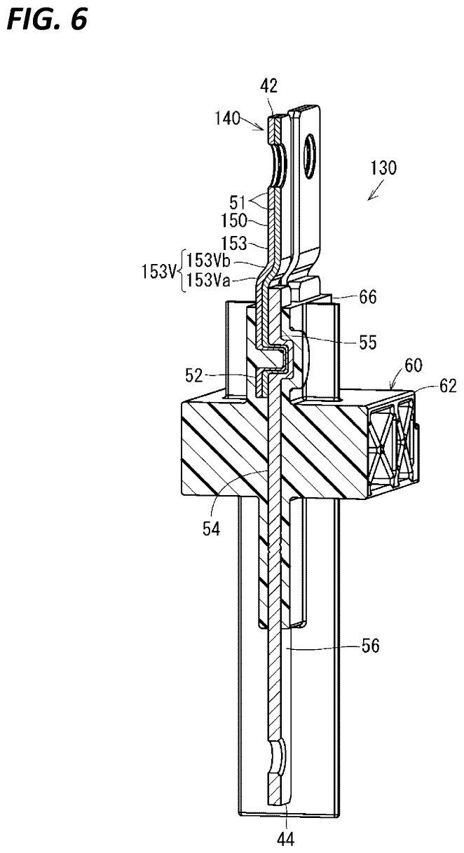

FIG. 6 is a perspective view partly in section showing a terminal block 130 according to a first modification. In the above embodiment, the laminated busbar portion 50 extends without being bent in the thickness direction.

In the first modification, a busbar 140 corresponds to the busbar 40. A laminated busbar portion 150 corresponding to the laminated busbar portion 50 includes an extending portion 153 corresponding to the extending portion 53. The extending portion 153 includes a bent portion 153V. The bent portion 153V is bent to change the position of the first connection end 42 with respect to the joining portion 52 in a thickness direction of the laminated busbar portion 150 between the joining portion 52 and the first connection end 42. More specifically, the bent portion 153V includes a bent part 153 Va near the joining portion 52 and a bent part 153Vb near the first connection end 42. The bent part 153 Va is bent from one surface of the single-layer joining portion 55 toward an extension of the single-layer joining portion 55. The bent part 153 Va is bent toward a side opposite to the bent part 153 Va so that a part closer to the tip side than the bent part 153 Va is arranged along the extension of the single-layer joining portion 55. That is, the bent portion 153V is bent into a crank shape including the bent parts bent in directions opposite to each other.

In this way, the position of the first connection end 42 is easily adjusted in the thickness direction of the busbar 140. The position of the first connection end 42 can be adjusted to the position of the busbar 18 as the connection destination.

In this embodiment, the first connection end 42 is arranged at the position near the single-layer busbar portion 54, here at the same position as the single-layer busbar portion 54.

For example, in the case of designing the mechanically/electrically integrated unit 10, the busbar 18 is assumed to be set at a position capable of overlapping a single-layer busbar portion held by a terminal block on the premise of a busbar formed by one metal plate. According to this modification, since the first connection end 42 is arranged at the position near the single-layer busbar portion 54 in the thickness direction of the busbar 140, the first connection end 42 is easily connected to the busbar 18 set as described above.

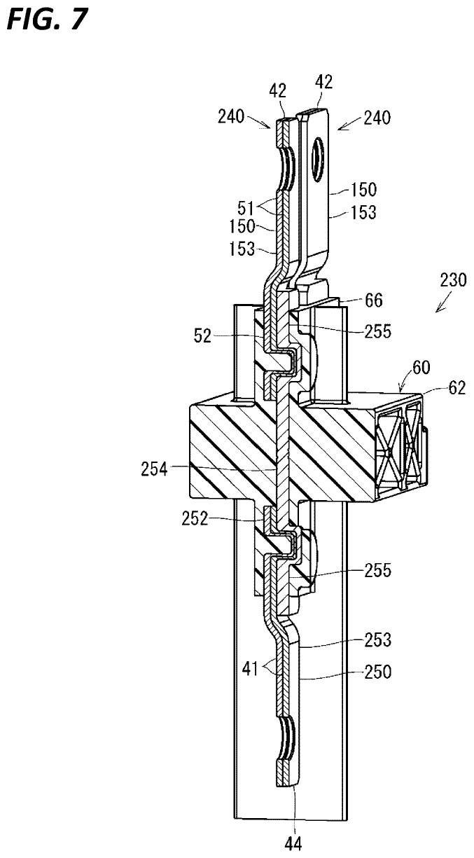

FIG. 7 is a perspective view partly in section showing a terminal block 230 according to the second modification. In the above embodiment, one end of the busbar 40 is the laminated busbar portion 50, and the other end is the single-layer busbar portion 54.

In the second modification, one end of a busbar 240 corresponding to the busbar 40 is a first laminated busbar portion 150 and the other end is a second laminated busbar portion 250.

That is, in the second modification, the busbar 240 includes the first and second laminated busbar portions 150, 250 as laminated busbar portions.

The first laminated busbar portion 150 is the laminated busbar portion 150 described in the embodiment and includes a joining portion 52 and an extending portion 153.

The second laminated busbar portion 250 includes a joining portion 252 corresponding to the joining portion 52 and an extending portion 253 corresponding to the extending portion 153, similarly to the laminated busbar portion 150. The tip of the extending portion 253 is a second connection end 44.

The joining portion 52 of the first laminated busbar portion 150 and the joining portion 252 of the second laminated busbar portion 252 are joined to a single-layer busbar portion 254 at mutually different positions.

The single-layer busbar portion 254 is a busbar formed by one metal plate. The single-layer busbar portion 254 differs from the single-layer busbar portion 54 in that both ends of the single-layer busbar portion 254 include single-layer joining portions 255 corresponding to the single-layer joining portion 55.

The joining portion 52 of the first laminated busbar portion 150 is joined to the single-layer joining portion 255 on one end side, and the joining portion 252 of the second laminated busbar portion 250 is joined to the single-layer joining portion 255 on the other end side. The first and second laminated busbar portions 150, 250 extend toward sides opposite to each other. Note that a relationship of the second laminated busbar portion 250 with the block body 60 is the same as that of the first laminated busbar portion 150 with the block body 60 except that the first and second laminated busbar portions 150, 250 extend from the block body 60 toward the sides opposite to each other.

According to this second modification, the position shift absorbing performance of the first and second connection ends 42, 44 can be enhanced on both ends of the busbar 240. For example, the position of the second connection end 44 can be adjusted when it is difficult to adjust the position of the coil connection end 26 in the case 22.

Further, since the busbar 240 can be integrated with the block body 60 regardless of the extension direction of the busbar 240 by symmetrically configuring the one end and the other end of the busbar 240, manufacturing is facilitated. Further, since the first and second laminated busbar portions 150, 250 can have the same shape, the number of types of manufacturing components can be reduced and the mounted positions of the single-layer joining portions 255 on the two single-layer joining portions 255 need not be distinguished. Manufacturing is facilitated also in this aspect.

Note that, in the above embodiment, the first connection end outside the case may be a single-layer busbar portion and the second connection end in the case may be a laminated busbar portion.

Further, in the above embodiment and respective modifications, the laminated busbar portion(s) 50, 150, 250 are arranged on one principal surface of the single-layer busbar portion 54, 254. However, the plurality of plate members constituting the laminated busbar portion 50, 150, 250 may be divided and arranged on both surface sides of the single-layer busbar portion 54, 254. In this case, the respective plate members may be appropriately bent in the thickness direction and overlapped at the connection end(s).

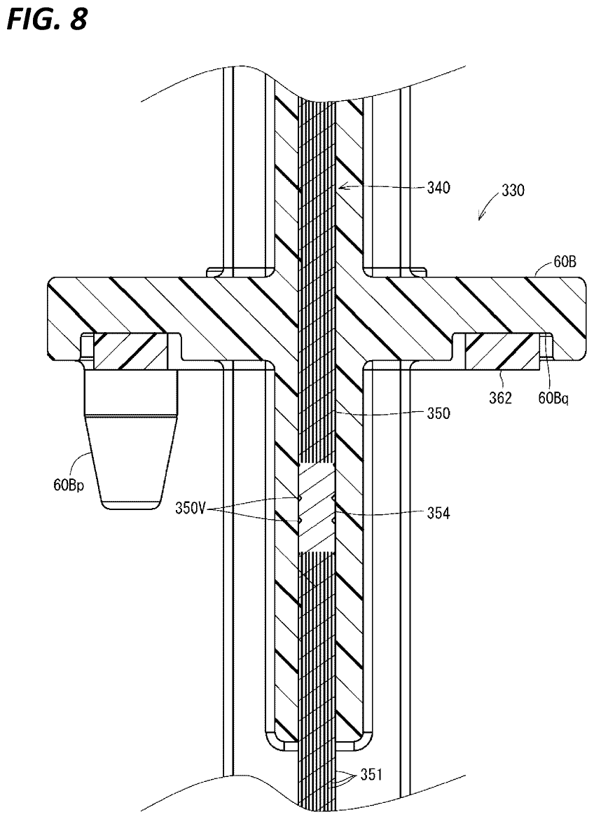

In the above embodiment and respective modifications, the laminated busbar portion(s) 50, 150, 250 is/are joined to the single-layer busbar portion 54, 254. Like a terminal block 330 and a busbar 340 shown in a third modification shown in FIG. 8, a single-layer busbar portion 354 and a laminated busbar portion 350 may be formed by an integrally continuous single metal member. Here, that the single metal member is formed to be integrally continuous means that a metal forming process such as rolling, press-working, machining or cutting is applied to a solid metal member without dividing the solid metal member into a plurality of components, i.e. forming without joining separate components.

Thus, the single metal member is formed to be integrally continuous in the thickness direction in the single-layer busbar portion 354. It is assumed that no joint marks due to welding or the like of a plurality of plate members are left in the single-layer busbar portion 354. Since the metal member is in a solid state without any gap in the single-layer busbar portion 354, the intrusion of water into the single-layer busbar portion 354 is suppressed.

The laminated busbar portion 350 is separated into a plurality of parts in the thickness direction. That is, in the laminated busbar portion 350, a plurality of plate-like parts 351 are laminated. Base ends of the respective plate-like parts 351 are integrally connected to either one end of the single-layer busbar portion 354. Thus, no joining portions are present between the laminated busbar portions 350 and the single-layer busbar portion 354. For example, the outward facing surfaces of the plate-like parts 351 located on the outmost layers, out of the plurality of plate-like parts 351, and those of the single-layer busbar portion 354 are flush and continuous with each other. Gaps for separating the plate-like parts 351 are present between the outward facing surfaces of the both plate-like parts 351 located on the outermost layers, out of the plurality of plate-like parts 351. Thus, in the laminated busbar portion 350, the respective plate-like parts 351 are laminated in a relatively position shiftable state.

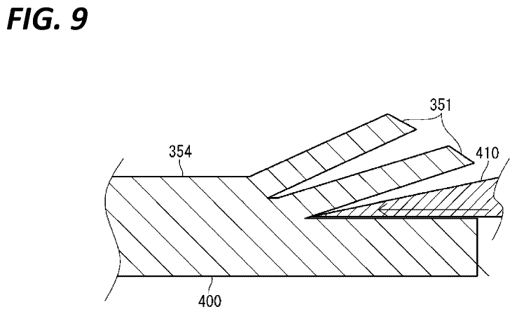

The laminated busbar portion 350 is, for example, a part formed by skiving a plate member 400 as shown in FIG. 9. Skiving means a processing of cutting the surface of a metal member into thin slices. For example, the plate member 400 made of metal serving as a base material for forming the single-layer busbar portion 354 and the laminated busbar portion 350 is prepared. Then, the surface of an end part of the plate member 400 for forming the laminated busbar portion 350 is cut to be sliced by a blade 410 for skiving. A part for constituting the single-layer busbar portion 354 is left as a single-layer plate-like part without being skived. The skived parts are laminated as the plate-like parts 351 while being connected to the single-layer busbar portion 354. In this way, the busbar 340 is formed.

Note that, in an example shown in FIG. 8, the single-layer busbar portion 354 is shorter than the single-layer busbar portion 54 and the like in the above embodiment, but this length is not particularly limited.

In this modification, grooves 350V along a direction intersecting (here, orthogonal to) an extension direction of the busbar 340 are formed in the outer surfaces in the thickness direction of the single-layer busbar portion 354. These grooves 350V can function to keep the sealant 70 (see FIG. 4) on the single-layer busbar portion 354 if the sealant 70 is interposed between a block body 60B corresponding to the block body 60 and the single-layer busbar portion 354.

In this modification, an annular seal 362 is arranged in an annular groove 60Bg formed in a part facing the surface of the case 22, out of the block body 60B. The annular seal 362 is interposed in a compressed state between the block body 60B and the surface of the case 22 to seal between the block body 60B and the case 22. A configuration example of the annular seal is not limited to this example and the annular seal may be interposed between the block body and the mounting hole 22h1.

In this modification, the block body 60B is formed with a positioning pin 60Bp, and this positioning pin 60Bp is inserted into a positioning hole formed in the case 22. The positioning pin 60Bp may be omitted.

According to this modification, since water does not pass inside the single-layer busbar portion 354, sealability can be improved in the single-layer busbar portion 354.

Further, since joining portions of the single-layer busbar portion 354 and the laminated busbar portion 350 are unnecessary, the busbar 340 can be reduced in size.

Further, the respective configurations described in the above embodiment and respective modifications can be appropriately combined without contradicting each other.

### LIST OF REFERENCE NUMERALS

10 mechanically/electrically integrated unit
12 inverter
18 inverter-side busbar
18h screw insertion hole
20 rotating electric machine (device)
22 case
22h1 mounting hole
22h2 screw hole
24 armature
26 coil connection end
26h screw insertion hole
28 field magnet
30, 130, 230, 330 terminal block
40, 140, 240, 340 busbar
42 first connection end (connection end)
42h, 44h screw insertion hole
44 second connection end (single-layer connection end, connection end)
50, 350 laminated busbar portion
51 plate member
52, 252 joining portion
52P joining part
52a protrusion
52, 153, 253 extending portion
54, 254, 354 single-layer busbar portion
54g sealing groove
54g2 recess
55, 255 single-layer joining portion
55a recess
56 single-layer extending portion
60, 60B block body
60Bg annular groove
60Bp positioning pin
62 holding body
64 screwing portion
64h screw insertion hole
66, 67 extended holding portion
66P partial protrusion
68 partitioning portion
70 sealant
150 first laminated busbar portion
153V bent portion
153Va, 153Vb bent part
250 second laminated busbar portion
350V groove
351 plate-like part
362 annular seal
400 plate member
410 blade
N nut
S screw

1. A terminal block to be fixed to a device, comprising:
a busbar formed into an elongated shape; and
a block body to be fixed to the device while holding the busbar,
a part in an extension direction of the busbar being a laminated busbar portion formed by laminating a plurality of plate members, and at least a part of a remainder being a single-layer busbar portion,
the laminated busbar portion including a joining portion joined to the single-layer busbar portion and an extending portion extending from the joining portion,
a tip of the extending portion being a connection end and at least the connection end projecting from the block body,
the joining portion being a part joined by pressing, welding or screwing, and
each of the plurality of plate members laminated in the laminated busbar portion being thinner than the single-layer busbar portion.

2. The terminal block of claim 1, wherein at least a part in the extension direction of the single-layer busbar portion is covered by the block body.

3. The terminal block of claim 2, wherein a sealant for filling a gap between the single-layer busbar portion and the block body is interposed between the single-layer busbar portion and the block body.

4. The terminal block of claim 3, wherein:
a sealing groove is formed in a direction intersecting the extension direction of the busbar in an outer peripheral surface of the single-layer busbar portion, and
the sealant is interposed between the sealing groove and the block body.

5. (canceled)

6. The terminal block of claim 1, wherein the extending portion includes a bent portion bent to change a position of the connection end with respect to the joining portion in a thickness direction of the laminated busbar portion between the joining portion and the connection end.

7. The terminal block of claim 1, wherein the connection end includes a screw insertion hole.

8. The terminal block of claim 1, wherein:
the single-layer busbar portion includes a single-layer joining portion joined to the joining portion and a single-layer extending portion extending from the single-layer joining portion, and
a tip of the single-layer extending portion is a single-layer connection end and at least the single-layer connection end projects from the block body.

9. The terminal block of claim 1, wherein:
the laminated busbar portion includes a first laminated busbar portion and a second laminated busbar portion,
each of the first and second laminated busbar portions includes the joining portion and the extending portion, and
the joining portion of the first laminated busbar portion and the joining portion of the second laminated busbar portion are joined to the single-layer busbar portion at mutually different positions.

10. The terminal block of claim 1, wherein a joining part of the joining portion and the single-layer busbar portion is covered by the block body.

11. (canceled)

12. (canceled)

13. A busbar formed into an elongated shape, comprising:
a laminated busbar portion formed by laminating a plurality of plate members, and
a single-layer busbar portion joined to the laminated busbar portion,
the laminated busbar portion including a joining portion joined to the single-layer busbar portion and an extending portion extending from the joining portion,
the joining portion being a part joined by pressing, welding or screwing, and
each of the plurality of plate members laminated in the laminated busbar portion being thinner than the single-layer busbar portion.

14. (canceled)

15. (canceled)
